(19) United States
(12) Patent Application Publication
(10) Pub. No.: US 2017/0091326 A1
(43) Pub. Date: Mar. 30, 2017

(54) MANAGING SEARCH ENGINES USING DYNAMIC SIMILARITY

(71) Applicant: Linkedln Corporation, Mountain View, CA (US)

(72) Inventors: Michael Chernyak, Los Gatos, CA (US); Diego Buthay, San Francisco, CA (US)

(21) Appl. No.: 14/970,121

(22) Filed: Dec. 15, 2015

Related U.S. Application Data
(60) Provisional application No. 62/234,970, filed on Sep. 30, 2015.

(51) Int. Cl. G06F 17/30

(52) U.S. Cl. CPC G06F 17/30864; G06F 17/30424

(57) ABSTRACT

This disclosure relates to systems and methods for managing a search engine using dynamic similarity. A method includes retrieving a query submitted to a production search engine, executing the query at a testing search engine to generate testing search results, comparing the production search results with the testing search results to generate a correlation coefficient, selecting a similarity threshold constraint using the correlation coefficient, and flagging the testing search engine as valid in response to the correlation coefficient satisfying the similarity threshold constraint.

### RELATED APPLICATIONS

This application claims the priority benefit of U.S. Provisional Application No. 62/234,970, entitled “MANAGING SEARCH ENGINES USING DYNAMIC SIMILARITY,” filed Sep. 30, 2015 which is hereby incorporated herein by reference in its entirety.

### TECHNICAL FIELD

The subject matter disclosed herein generally relates to networked information and, more particularly, to managing search engines using dynamic similarity.

### BACKGROUND

As technology advances, network connected databases are more available for users to search and find information about almost anything. Conventionally, the various databases are accessed over a network connection. In some examples, the network is a very large wide area network such as, for example, the Internet.

A search engine that searches data available via the Internet typically accesses a wide variety of different servers. As such, the data pulled from these different servers is constantly changing or updating. Therefore search results from a search engine that accesses such a wide variety of different servers consists of different results.

In such a scenario, as a search engine is updated or modified in any way, an administrator for the search engine would like to verify the performance of the search engine. Because the nature of the data is frequently changing, verifying that a modified search engine still returns correct result is difficult. In certain examples, as people update profiles, change profile data, or modified data stored at a remote server, results from a search engine correspondingly change.

In one example a regression test is use to test the configuration of a search engine. However, because the data is frequently changing, a typical regression test fails. This is because the results of a modified search engine may not match results of a search engine that is currently in production.

In another example, the inputs for the search engines are also different. For example an administrator for a search engine may configure the search engine to operate using a different language. Typical regression testing also fails in this scenario because the search engine configured to operate using a German language cannot be technically compared to a search engine configured to operate using an English language. Therefore, because inputs may be different and outputs may be different, determining whether a newly configured search engine is performing as expected is difficult.

In another example, developing test use cases to verify the performance of a newly configured search engine is also difficult because administrator would have to configure these cases based on expected search results. Again, because expected results are frequently changing such use cases cannot adequately indicate whether a newly configured search engine is operating correctly.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating one example scenario that includes a search engine system according to one example embodiment.

FIG. 3 is a schematic block diagram illustrating another example scenario that includes a social network expansion system, according to one example embodiment.

FIG. 4 is another block diagram illustrating components of a search engine system, according to one example embodiment.

FIG. 5 is a flow chart diagram illustrating a method of managing a search engine using dynamic similarity, according to an example embodiment.

FIG. 6 is a flow chart diagram illustrating another method of managing a search engine using dynamic similarity, according to an example embodiment.

FIG. 7 is a flow chart diagram illustrating a method of managing a search engine using dynamic similarity, according to an example embodiment.

FIG. 8 is a flow chart diagram illustrating a method of managing a search engine using dynamic similarity, according to another example embodiment.

FIG. 9 is a flow chart diagram illustrating a method of managing a search engine using dynamic similarity, according to one example embodiment.

FIG. 10 is a block diagram illustrating components of a machine, according to some example embodiments, able to read instructions from a machine-readable medium (e.g., a machine-readable storage medium) and perform any one or more of the methodologies discussed herein

### DETAILED DESCRIPTION

The description that follows includes systems, methods, techniques, instruction sequences, and computing machine program products that embody illustrative embodiments of the invention described in the present disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to managing search engines using dynamic similarity. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Techniques for managing search engines using dynamic similarity have been developed that provide for retrieving a set of queries submitted to a production search engine 220, executing queries at a testing search and to generate testing search results, comparing the production search results with the testing search results to generate a correlation coefficient, selecting a similarity threshold constraint using the correlation coefficient, and flagging the testing search engine as valid in response to the correlation coefficient satisfying similarity threshold constraint.

As described herein, the system compares results from a testing search engine with those from a live production search engine 220. In this way, verification of a testing search engine is accomplished which provides a performance baseline of live results used to verify the testing search engine based, at least in part, on the results from the testing search engine being sufficiently similar results from the live production search engine 220 as will be further described.

As one skilled in the art may appreciate, application of traditional regression testing principles fails in this scenario because traditional regression testing relies on a limited number of test cases. Validation of a search engine in this scenario, would be accomplished based on results of a testing search engine being identical to results of the production search engine (e.g. production search engine 220). However, as previously described, search results from the live production search engine 220 frequently change. Thus, application of traditional regression testing principles cannot successfully validate a testing search engine. As one skilled in the art may appreciate, regression testing does not discriminate between good and/or bad results but only if results match between systems.

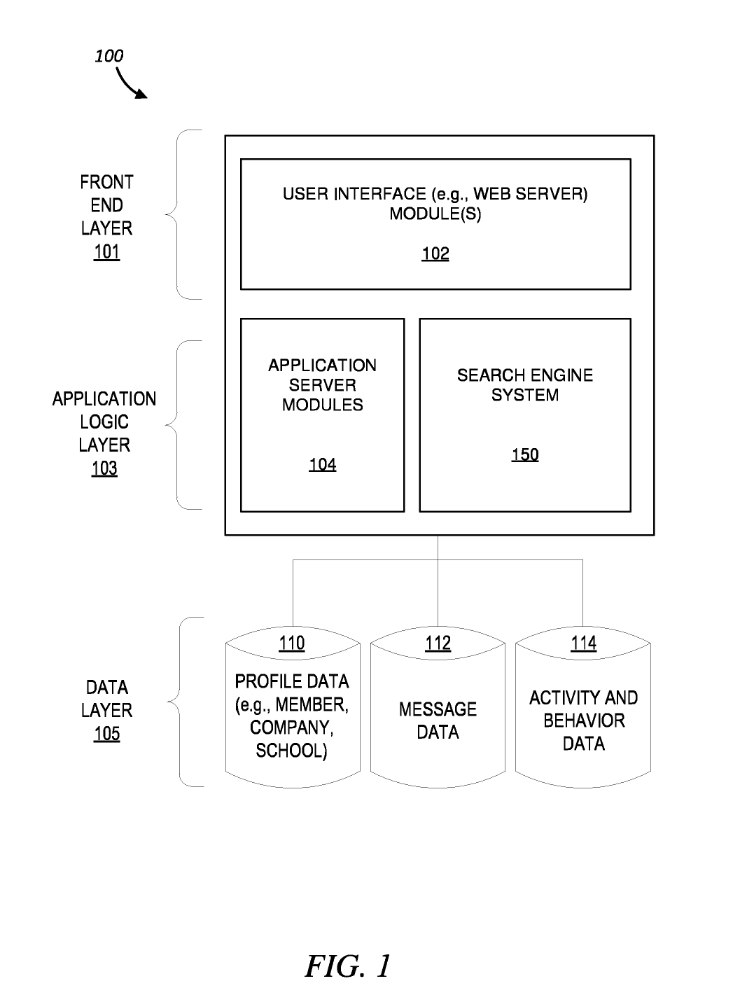

FIG. 1 is a block diagram illustrating various components or functional modules of an online social networking service 100, in an example embodiment. The online social networking service 100 may be utilized to manage a search engine using dynamic similarity operating as part of the online social networking service 100. In one example, the online social networking service 100 includes the search engine system 150 that performs the various management operations described herein.

A front end layer 101 consists of one or more user interface modules (e.g., a web server) 102, which receive requests from various client-computing devices and communicate appropriate responses to the requesting client devices. For example, the user interface module(s) 102 may receive requests in the form of Hypertext Transport Protocol (HTTP) requests, or other web-based, application programming interface (API) requests. In another example, the front end layer 101 receives requests from an application executing via a member's mobile computing device. In one example, a member submits media content to be transmitted to other members of the online social networking service 100.

An application logic layer 103 includes various application server modules 104, which, in conjunction with the user interface module(s) 102, may generate various user interfaces (e.g., web pages, applications, etc.) with data retrieved from various data sources in a data layer 105.

In some examples, individual application server modules 104 may be used to implement the functionality associated with various services and features of the online social networking service 100. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service 100 may be embodied in their own application server modules 104. Alternatively, various applications may be embodied in a single application server module 104.

In some examples, the online social networking service 100 includes the search engine system 150, which may retrieve queries from a production search engine (e.g., production search engine 220), execute the queries at a testing search engine, and generate a correlation coefficient using results of the production search results of the testing search engine. In response to the correlation coefficient satisfying a similarity threshold constraint, the system may flag the testing search engine as valid. In another example embodiment, the system may replace the production search engine with the testing search engine.

As illustrated, the data layer 105 includes, but is not necessarily limited to, several databases 110, 112, 114, such as a database 110 for storing profile data, including both member profile data as well as profile data for various organizations. In certain examples, the profile data includes the properties and/or characteristics of members of the online social networking service 100. Consistent with some examples, when a person initially registers to become a member of the online social networking service 100, the person may be prompted to provide some personal information, such as his or her name, age (e.g., birthdate), gender, sexual orientation, interests, hobbies, contact information, home town, address, the names of the member's spouse and/or family members, educational background (e.g., schools, majors, matriculation and/or graduation dates, etc.), occupation, employment history, skills, religion, professional organizations, and other properties and/or characteristics of the member. This information is stored, for example, in the database 110. Similarly, when a representative of an organization initially registers the organization with the online social networking service 100, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

The online social networking service 100 may provide a broad range of other applications and services that allow members the opportunity to share and receive information, often customized to the interests of the member. For example, with some examples, the online social networking service 100 may include a message sharing application that allows members to upload and share messages with other members. With some examples, members may be able to self-organize into groups, or interest groups, organized around a subject matter or topic of interest. With some examples, the online social networking service 100 may host various job listings providing details of job openings within various organizations.

As members interact with the various applications, services, and content made available via the online social networking service 100, information concerning content items interacted with, such as by viewing, playing, and the like, may be monitored, and information concerning the interaction may be stored, for example, as indicated in FIG. 1 by the database 114. In one example embodiment, the interactions are in response to receiving a message requesting the interaction.

Although not shown, with some examples, the online social networking service 100 provides an application programming interface (API) module via which third-party applications can access various services and data provided by the online social networking service 100. For example, using an API, a third-party application may provide a user interface and logic that enables the member to submit and/or configure a set of rules used by the social network expansion system 150. Such third-party applications may be browser-based applications, or may be operating system specific. In particular, some third-party applications may reside and execute on one or more mobile devices (e.g., phone, or tablet computing devices) having a mobile operating system.

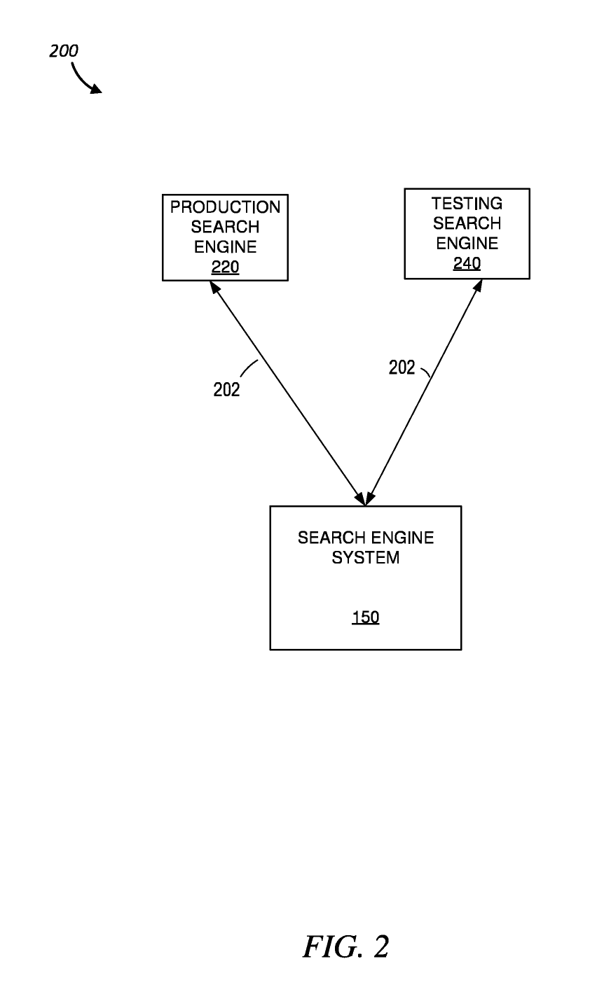

FIG. 2 is a block diagram illustrating one example scenario 200 that includes a search engine system 150 according to one example embodiment. In one example embodiment, the system includes a production search engine 220, the testing search engine 240, and the search engine system 150.

In one example embodiment, the production search engine 220 is configured to generate live production search results. For example the production search engine 220 may be accessible by one or more network clients. In one specific example, the network clients connect to the production search engine 220 and submit one or more queries. In response, the production search engine 220 generates live search results. As described herein, live search results at least includes search results found in one or more currently operating networks.

In another example embodiment, the search engine system 150 retrieves the receipt queries from the production search engine 220. In response to receiving the queries, the search engine system may transmit the query's to the testing search engine 240. In one example embodiment, the testing search engine 240 is configured differently from the production search engine 220. In one example the testing search engine 240 executes a different version of executable code as compared with the production search engine 220. In another example embodiment the testing search engine 240 is configured using a different set of configuration parameters as compared with the production search engine 220.

In one example embodiment, the search engine system compares, for a given query, results from the production search engine 220 and results from the testing search engine 240. Due to the queries being executed at the testing search engine 240 at different time when the queries were executing at the production search engine 220, there may be variations in the search results. This may be the case even though in similar situations, the production search engine 220 and the testing search engine 240 would generate substantially similar results.

In one example embodiment, and as will be further described herein, the search engine system 150 is configured to generate a correlation coefficient using search results that correlate between the production search results and the testing search results. In one example, search results that match between the production search results in the testing search results increase the correlation coefficient. In another example, search results that do not match between the production search results in the testing search results decrease the correlation coefficient.

In another example embodiment, the search engine system 150 generates the correlation coefficient by first limiting the number of search results for all production search results and testing search results to a threshold number. For example a threshing number is 500, and the search engine system 150 includes the first 500 search results from the production search engine 220 and the testing searching.

In another example embodiment, the search engine system 150 search results to the testing search results that are included in the production search results but are not included in the testing search results. In one example the production search results and the testing search results are stored in a database. In response to a search result being included in the production search results but not included in the testing search results, the search engine system 150 as a record in the database so that the missing search results are included in the testing search results.

In one example embodiment the search engine system 150 drops search results from the testing search results but are not included in the production test results. In the example where the search results are stored in a database, the search engine system 150 removes a record in a database representing the search results to be dropped.

In another example embodiment, search engine system 150 generates a set of pairs by comparing each production search result with each testing search result. The search engine system 150 then generates a difference by subtracting the number of discordant pairs in the set of pairs from the number of concordant pairs in some of pairs. As described herein, discordant pairs are pairs where a rank or the search results in the pair in the production search results disagrees with the rank of the pair in the testing search results. Furthermore, as described herein, concordant pairs are pairs where the search results in the production search results agree with the rank (e.g., the order) of the pair in the testing search results.

The search engine system, in another example embodiment, then generate a difference by subtracting the number of discordant pairs in the set of pairs from the number of concordant pairs in the sum of pairs. In this example embodiment, the correlation coefficient is calculated by dividing the difference by a number of data pairs in the set. In one example, where the set of pairs includes 1,000 pairs and 900 pairs are concordant with 100 pairs be discordant, the difference described is 800 and the correlation coefficient is 0.8 (800/1000).

In one example embodiment, the search engine system 150 validates the testing search engine 240 on a weekly basis. For example on a given day of the week, the search engine system 150 retrieves the set of queries submitted to the production search engine 220, execution created the testing search engine, compares the results generates the correlation coefficient as previously described. Of course, other time periods may be used and this disclosure is not limited in this regard.

In one example embodiment, as an administrator modifies either configuration settings or executable code for the testing search engine 240, the search engine system 150 may validate the configuration of the testing search engine without user intervention. One benefit is the administrator may be quickly notified in response to the testing search engine not providing search results that are sufficiently close to search results generated by the production search engine 220. In one example adequate search results means a correlation coefficient being below a threshold value.

In another example embodiment, the search engine system 150 performs the operations described herein in response to an administrator of the testing search engine modifying the configuration. In one example, as an administrator updates executable code for the testing search engine, the search engine system 150 may immediately begin determining whether the testing search engine is generating correct results without user intervention.

In one example embodiment, the search engine system 150 selects a similarity threshold constraint using the correlation coefficient. In one example, the similarity threshold constraint includes the correlation coefficient exceeding a threshold value. In another example the similarity threshold constraint includes the correlation coefficient being below a threshold value. Of course, one skilled in the art may recognize other mathematical variations and this disclosure is meant to include all such variations.

In another example embodiment, the search engine system 150 replaces the production search engine 220 with the testing search engine in response to the similarity threshold constraint being satisfied. In one example queries being transmitted to the production search engine 220 are rerouted to the testing search engine 240, search results from the testing search engine 240 transmitted back to the client device that sent queries to the production search engine 220.

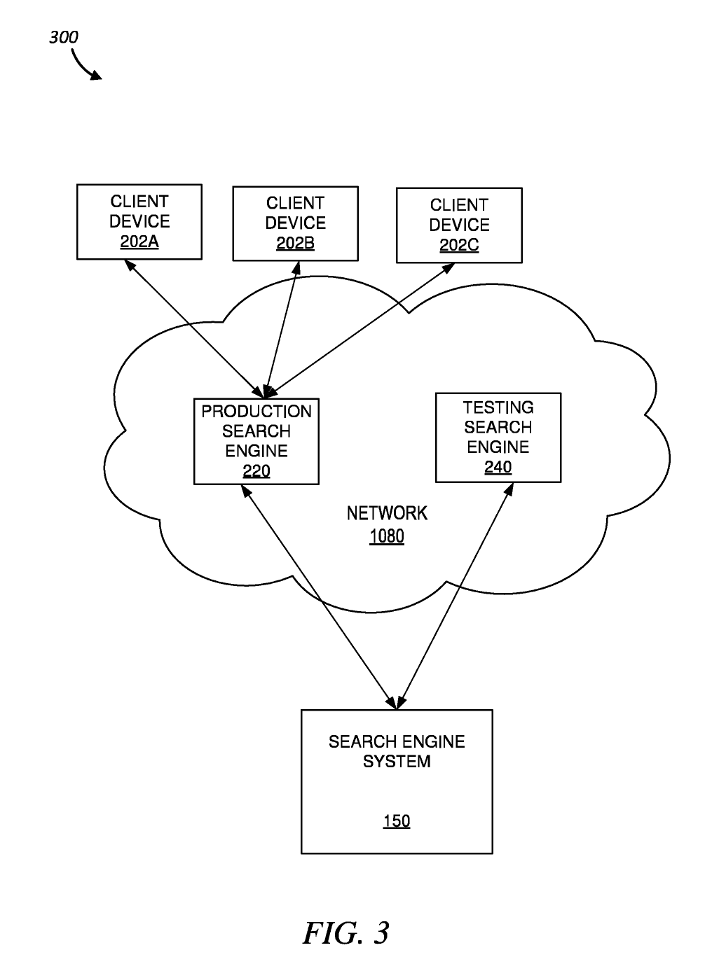

FIG. 3 is a schematic block diagram illustrating another example scenario 300 that includes a search engine system 150, according to one example embodiment. In one example embodiment, the scenario 300 includes client devices 202, the production search engine 220, the testing search engine 240, and the search engine system 150. In this example embodiment, the production search engine 220 and the testing search engine 240 operate as part of a network 1080.

In one example embodiment, the production search engine 220 receives queries from client device 202A, client device 202B and client device 202C. Each client device 202 may submit one or more queries to the production search engine 202. As one skilled in the art may appreciate, the client devices 202 may communicate with the production search engine 220 may any known or to be developed communication medium. In one example the communication medium includes a local area network. In another example the communication medium is a wide area network. Of course, many other communication meetings may be used and this disclosure is not limited in this regard. As indicated in FIG. 3, the search engine system 150 may or may not operate as part of the network 1080.

Another example embodiment, the production search engine 220 operate according to a first language, and the testing search engine 240 operates according to a second language. In one example the first language is English the second language is German. Of course any other languages may be used and this disclosure is not limited in this regard.

In this example embodiment, because the language of the production search engine 220 and the language of the testing search engine 240 are not the same, traditional regression testing methods do not work. This is because the inputs are different due to the first language in the second language not being the same language. Therefore, the management operations for the production search engine 220, the testing search engine 240, or any other search engine may verify that changes to a search engine do or do not cause the search engine to perform adequately.

In one example embodiment, after limiting the number of search results to a threshold number, and generating errors between the search results as previously described, the search engine system 150 employs Kendall rank correlation methods to determine whether the restricted search results from the production search engine 220 and the restricted search results from the testing engine 240 are sufficiently similar. In one example the search engine system 150 receives a similarity threshold constraint from a user, and in response to the correlation coefficient between the production search results in the testing search results exceeding the similarity threshold constraint, the search engine system 150 determines that the testing search engine generates sufficiently correct results.

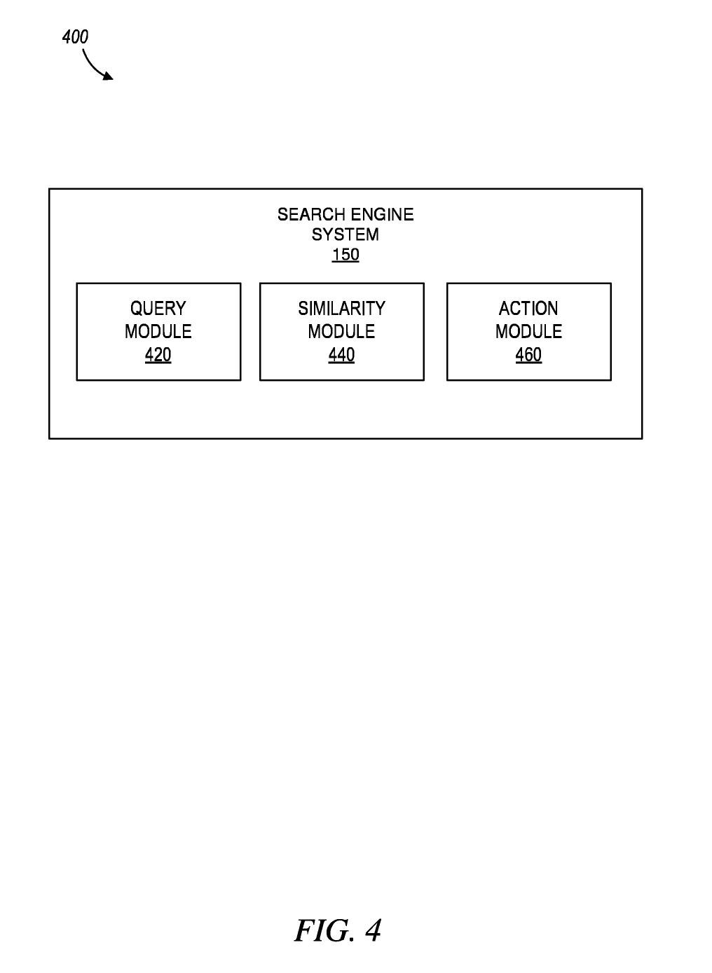

FIG. 4 is another block diagram illustrating components of a search engine system, according to one example embodiment. In this example embodiment, the search engine system 150 includes a query module 420, a similarity module 440, and an action module 460.

In one example embodiment, the query module 420 is configured to retrieve a query submitted to a production search engine 220. As described herein production search engine 220 is configured to generate live production search results in response to receiving queries from the mobile client devices.

In another example embodiment the query module 420 is configured to execute the query testing search engine to generate testing search results. As described herein, a testing search engine is a search engine with an altered configuration as compared with a production search engine 220. In one example, the altered configuration includes a configuration setting that is different than the production search engine 220. In another example, the altered configuration includes updated executable code that operates the search engine.

In another example embodiment, the similarity module 440 compares production search results with testing search results to generate a correlation coefficient using search results that correlate between the production search results in the testing search results. As described herein, the correlation coefficient may be calculated in a variety of different ways. In one example, the correlation coefficient is the result of dividing a number of concordant pairs by a number of discordant pairs as previously described. In another example embodiment, the correlation coefficient is calculated by subtracting the number of discordant pairs from a number of concordant pairs and dividing the difference by the total number of pairs in the set of search results.

In one example embodiment the similarity module 440. Limits the search results from the production search engine 220 and the search results from the testing search engine to a threshold number of results. In one example the threshold number of results is 1000, but of course this is not necessarily the case.

In another example embodiment, the similarity module 440 adds pairs that are included in the production search results into the testing search results. In one example embodiment, the similarity module 440 deletes pairs from the testing search results in response to the pairs not be included in the production search results. In these ways, the similarity module 440 increases the number of matching pairs between the production search results in the testing search results.

In one example embodiment, pairs that are added to the testing search results are added at a lower priority such as the likelihood of the pair being discordant is increased because the rank for the pair in the production search results has not been assigned a lower priority.

In order to determine whether a given pair is neither concordant or discordant, the similarity module 440 generate a limited set of pairs for both the production search results and the testing search results. In one example embodiment, the set of pairs includes each value in the production search results with each other value in the production search results. For example in response to their being 10 search results, the similarity module 440 generates 45 (9+8+7+6+5+4+3+2+1) unique pairs. In one example embodiment, the similarity module 440 as previously insured that the production search results include the same results as the testing search results. As a consequence, the unique pairs from the testing search results by the same as the need pairs from the production search results.

For each pair in the set of pairs, the pair is found in the set of pairs for the production search results and a set of pairs for the testing search results. In response to the rank of each search result in the pair matching the rank for the corresponding pair in the testing search results, the similarity module 440 determines that the pair is concordant. In response to the rank of each search result in the pair not matching the rank for the corresponding pair in the testing search results, the similarity module 440 determines that the pair is discordant. In another example embodiment, in response to the rank for a pair in the production search results matching the rank for the pair in the test search results, the pair is neither discordant nor concordant. In one example embodiment, for a given number of pairs in a set represented as ‘n’, a similarity coefficient ‘τ’ is calculated according to the Equation 1.

$$τ = \frac{\begin{matrix}( number of concordant pairs ) - \\ ( number of discordant pairs )\end{matrix}}{\frac{1}{2} n ( n - 1 )} . \qquad Equation 1$$

In this example embodiment, the resulting similarly coefficient is between −1 and 1. Furthermore, in response to the rankings of the pairs between the production search results in the testing search results matching for each pair in the set, the similarly coefficient will have a value of 1. In response to each pair in the set of pairs not matching the rank between the production search results in the testing search results, the similarity coefficient will be −1.

In one example embodiment, the action module 460 flags a testing search engine is in response to the correlation coefficient satisfying a similarity threshold constraint as described herein. In this way, an administrator for the testing search engine discreetly notified whether the current configuration for the testing search engine results in a testing search engine that generates sufficiently correct search results. This may be the case although the search results do not precisely match search results from the production search engine 220.

In another example embodiment, the action module 460 replaces the production search engine 220 the testing search engine 240 response to the similarity threshold constraint be satisfied by the correlation coefficient. In one example embodiment the action module 460 configures a network device to route traffic intended for the production search engine 220 to the testing search engine. Of course, one skilled in the art may recognize other ways to replace a production search engine with a testing search engine and this disclosure is meant to include all such ways.

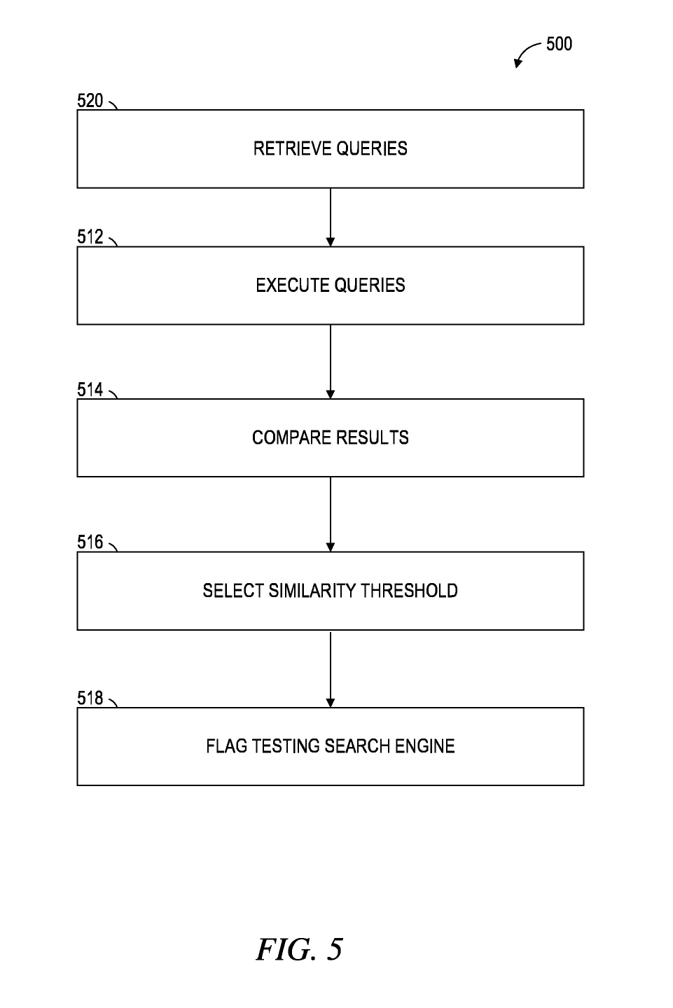

FIG. 5 is a flow chart diagram illustrating a method of managing search engines using dynamic similarity, according to an example embodiment. According to one example embodiment, the method 500 is performed by one or more modules of the search engine system 150 and is described by a way of reference thereto.

In one embodiment, the method 500 begins and at operation 520 the query module 420 retrieves a query submitted to a production search engine 220. In one example the production search engine is currently configured to accept queries from remote devices and responded with search results. In one example embodiment, the search engine returns search results that include links to remote servers that communicate via the Internet.

The method 500 continues at operation 512 and the query module 420 executes the query at a testing search engine. The method 500 continues at operation 514 and the similarity module 440 compares search results from the production search engine 220 was search results from the testing search engine. In one example the similarity module 440 generates the correlation coefficient using search results that correlate in rank between the production search results and the testing search results.

The method 500 continues at operation 516, and the similarity module 440 sets a similarity threshold constraint using the correlation coefficient. In one example, the similarity module 440 receives the similarity threshold constraint from an administrator of the search engine system 150. In one example, the similarity threshold constraint includes the correlation coefficient exceeding it threshold value. In another example similarity threshold constraint includes the correlation coefficient being below a threshold value.

The method 500 continues at operation 518 and the action module 460 flags the testing search engine as balance in response to the correlation coefficient satisfying the similarity threshold constraint. In one example the action module 460 flags the test engine by writing a record in a database to indicate that the testing search engine generates correct results.

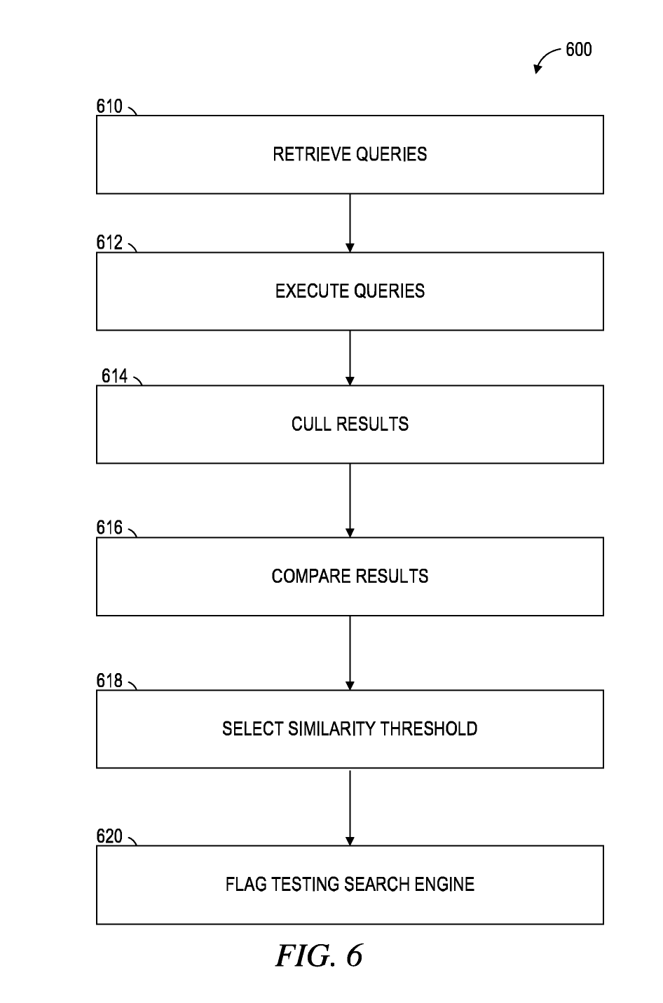

FIG. 6 is a flow chart diagram illustrating another method 600 of managing a search engine using dynamic similarity, according to an example embodiment. According to one example embodiment, the method 600 is performed by one or more modules of the search engine system 150 and is described by a way of reference thereto.

One example embodiment, the method 600 begins and at operation 610 the query module 420 retrieves the query submitted to the production search engine 220. The method 600 continues at operation 612 and the query module 420 executes the query at the testing search engine 240. The method 600 continues at operation 614 in the similarity module 440 culls search results from the testing search results that are not included in the production test results. In one example, the testing search results includes a link to a remote server. In response to the production search results not including the link, the similarity module 440 removes the link from the testing search results.

The method 600 continues at operation 616 and the similarity module 440 compares search results from the production search engine 220 with search results from the testing search engine. In one example, the similarity module 440 generates the correlation coefficient using search results that correlate in rank between the production search results and the testing search results.

The method 600 continues at operation 618, and the similarity module 440 sets a similarity threshold constraint using the correlation coefficient as previously described. The method 600 continues at operation 620 and the action module 460 flags the testing search engine as valid in response to the correlation coefficient satisfying the similarity threshold constraint. In one example the action module 460 flags the test engine by transmitting a message to a remote server that indicates whether the testing search engine is valid.

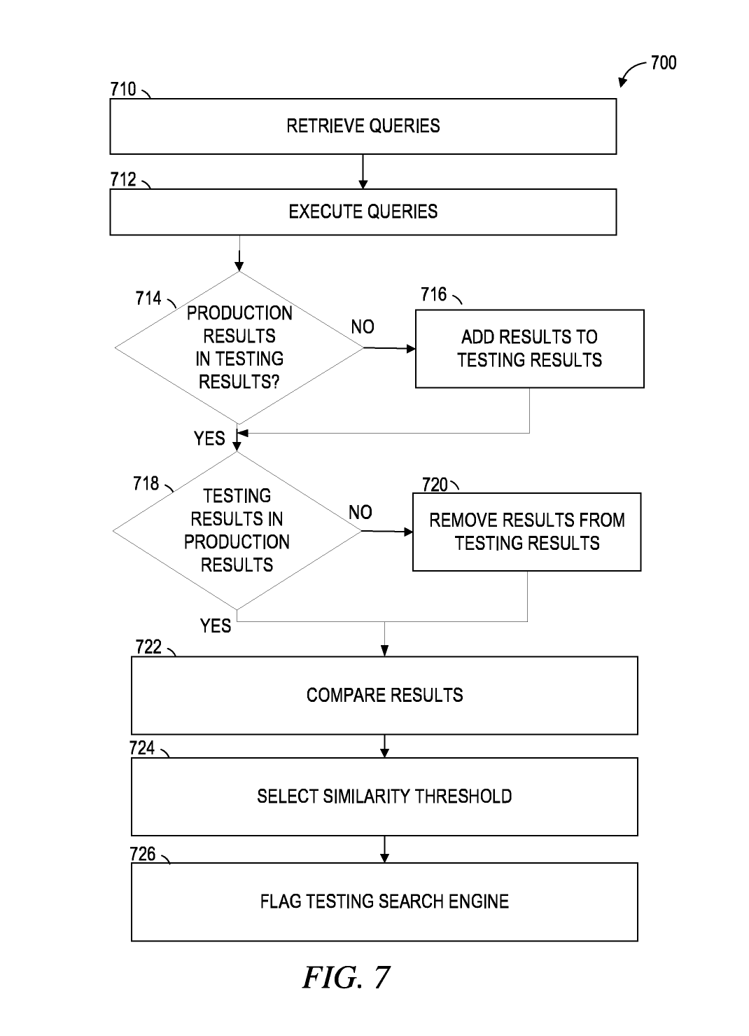

FIG. 7 is a flow chart diagram illustrating a method 700 of managing a search engine using dynamic similarity, according to an example embodiment. According to one example embodiment, the method 700 is performed by one or more modules of the search engine system 150 and is described by a way of reference thereto.

In one example embodiment, the method 700 begins and at operation 710 the query module 420 retrieves two or more queries submitted to a production search engine 220. The method 700 continues at operation 712 and the query module 420 executes the two or more queries at a testing search engine 240.

The method 700 continues at operation 714 and the similarity module 440 determines search results that are included in the production search results but are not included in search results from the testing search engine 240. In response to search results being included in the production search results but not being included in the testing search results the method continues at operation 716 and the similarity module 440 adds missing results to the testing search results. The method continues at operation 718. In response to there being no search results that are in the production search results and not in the testing search results the method continues at operation 718.

At operation 718, the similarity module 440 determines whether there are search results in the testing search results that are not included in the production search results. In response to the testing search results including search results that are not included in the production search results, the method continues at operation 720 and the similarity module 440 removes the results from the testing search results. The method continues at operation 722. In response to the testing search results including search results that are not included in the production search results, the method continues at operation 722.

At operation 722, the similarity module 440 compares the production search results with the testing search results generated correlation coefficients as described herein. The method 700 continues at operation 724 and the similarity module 440 selects the similarity threshold constraint using the correlation coefficient. The method 700 continues at operation 726, and action module 460 flags the testing search engine as valid in response to the correlation coefficient satisfying similarity threshold constraint.

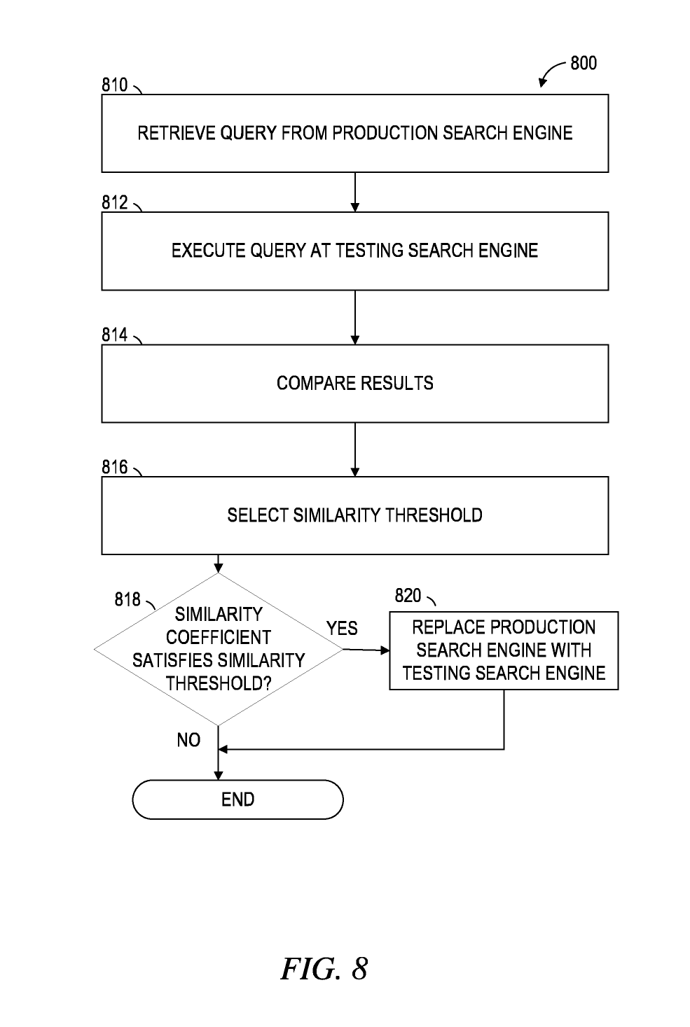

FIG. 8 is a flow chart diagram illustrating a method 800 of managing a search engine using dynamic similarity, according to another example embodiment. According to one example embodiment, the method 800 is performed by one or more modules of the search engine system 150 and is described by a way of reference thereto.

In one example embodiment, the method 800 begins and at operation 810, the query module 420 retrieves a query submitted to the production search engine 220. The method 800 continues at operation 812 and the query module 420 executes the query at the testing search engine 240. The method 800 continues at operation 814 and the similarity module 440 compares results of the query executed at the production search engine 220 results of the query executed at the testing search engine.

The method 800 continues that operation 816 and the similarity module 440 selects a similarity threshold constraint using the correlation coefficient generated at operation 814. The method 800 continues at operation 818 and the similarity module 440 determines whether the correlation coefficient satisfies the similarity threshold constraint. In response to the similarity coefficient not satisfying similarity threshold constraint, the method 800 ends. In response to the similarity coefficient satisfying the similarity threshold constraint, the method continues at operation 820 and detection module 460 replaces the production search engine 220 with the testing search engine.

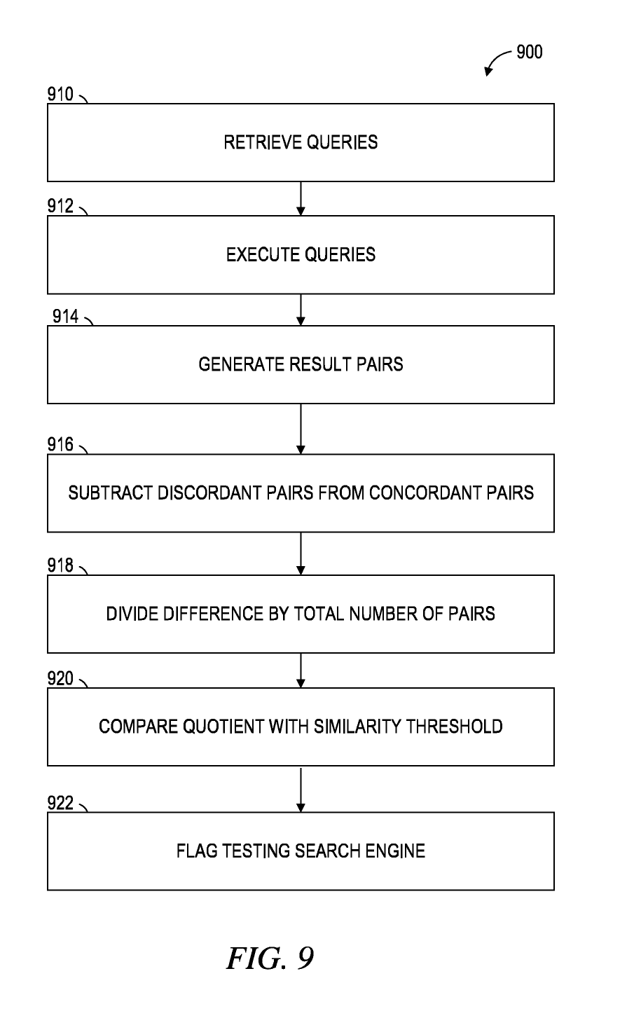

FIG. 9 is a flow chart diagram illustrating a method 900 of managing a search engine using dynamic similarity, according to one example embodiment. According to one example embodiment, the method 900 is performed by one or more modules of the search engine system 150 and is described by a way of reference thereto.

In one example embodiment, the method 900 begins and at operation 910 the query module 420 retrieves the query received by a production search engine 220. In one example the query module 420 request the query from the production search engine 220. In another example, the query module 420 requests all recent queries executed over a recent period of time. In one example the query module 420 requests queries received by the production search engine 220 on a daily basis.

The method 900 continues at operation 912 and the query module 420 executes the query at the testing search engine 240. The method 900 continues that operation 914 in the similarity module generates unique errors or the search results from the production search engine 220 and search results from the testing search engine. The method 900 continues at operation 916 and the similarity module 440 subtracts a number of discordant pairs between the pairs from the production search results and the pairs from the testing search results from the number of concordant pairs between the pairs from the production search results in the pairs from the testing search results.

The method 900 continues at operation 918, and the similarity module for 40 divides the difference between concordant pairs and the discordant pairs by the total number of pairs. In one example embodiment, the similarity module 440 removes pears from the testing search results and/or asked pairs to the testing search results so that the generated unique pairs for the production search results in the testing search results are the same. In this example embodiment the total number of pairs is the number of unique pairs for each of the search results.

The method 900 continues and at operation 920 the similarity module 440 compares resulting quotient (e.g., the correlation coefficient) with the similarity threshold constraint. The method 900 continues at operation 922 and action module 460 flags the testing search engine as valid in response to the correlation coefficient satisfying similarity threshold constraint.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-9 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Machine Architecture and Machine-Readable Medium

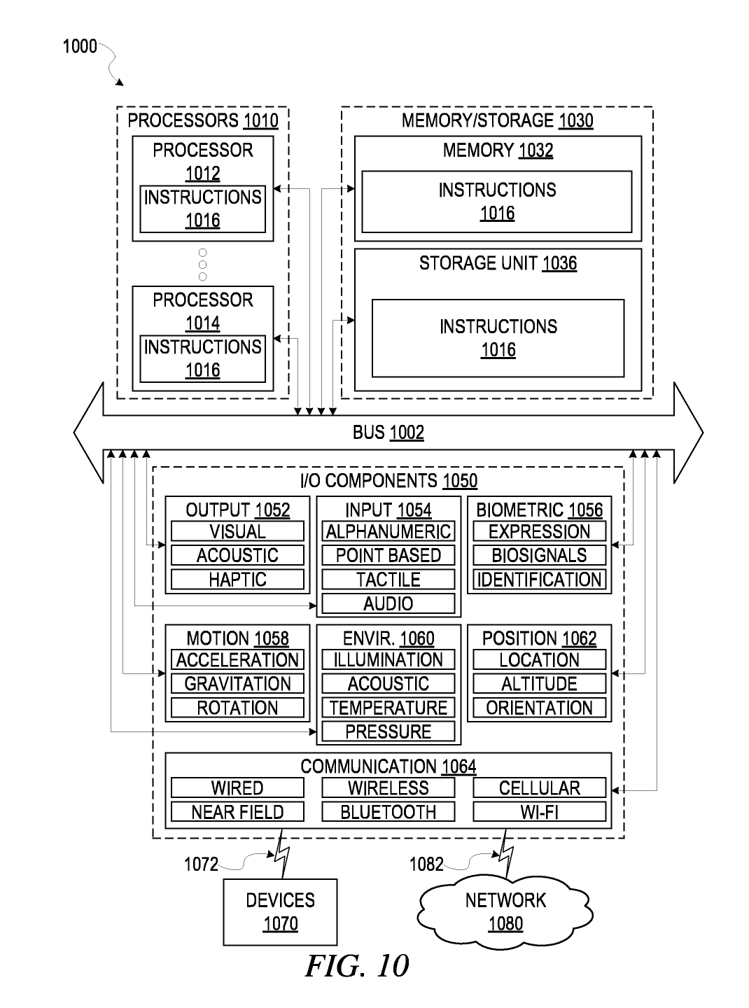

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions may cause the machine to execute the flow diagrams of FIGS. 5-9. Additionally, or alternatively, the instructions may implement one or more of the components of FIG. 4. The instructions transform the general, non-programmed machine into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), or any machine capable of executing the instructions 1016, sequentially or otherwise, that specify actions to be taken by machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1012 and processor 1014 that may execute instructions 1016. The term “processor” is intended to include multi-core processor that may comprise two or more independent processors (sometimes referred to as “cores”) that may execute instructions contemporaneously. Although FIG. 10 shows multiple processors, the machine 1000 may include a single processor with a single core, a single processor with multiple cores (e.g., a multi-core process), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of processors 1010 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or other type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to devices 1070. The term “transmission medium” shall be taken to include any intangible medium that is capable of storing, encoding, or carrying instructions 1016 for execution by the machine 1000, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium having instructions stored thereon, which, when executed by a processor, cause the system to:
retrieve a query submitted to a production search engine, the production search engine configured to generate production search results;
execute the query at a testing search engine to generate testing search results, the testing search engine configured differently from the production search engine;
generate a set of result pairs by pairing each of a plurality of testing search results with each of a plurality of production search results;
generate a correlation coefficient using the set of result pairs based on a number of result pairs that are concordant and a number of result pairs that are discordant;
select a similarity threshold constraint using the correlation coefficient; and
validate the testing search engine in response to the correlation coefficient satisfying the similarity threshold constraint.

2. The system of claim 1, wherein the production search results and the testing search results are limited to a threshold number of results.

3. The system of claim 2, wherein the instructions further cause the system to add search results to the testing search results that are included in the production search results but are not included in the testing search results.

4. The system of claim 2, wherein the instruction further cause the system to drop search results from the testing search results that are not included in the production search results.

5. The system of claim 2, wherein the instruction further cause the system to lower a priority value for search results that are included the testing search results and are not included in the production search results, the correlation coefficient calculated using the priority value.

6. The system of claim 1, wherein the instruction further cause the system to replace the production search engine with the testing search engine in response to the similarity threshold constraint being satisfied.

7. The system of claim 1, wherein the instruction further cause the system to, generate a difference by subtracting the number of discordant pairs from the number of concordant pairs, the correlation coefficient calculated by dividing the difference by a number of data pairs in the set of result pairs.

8. A method comprising:
retrieving a query submitted to a production search engine, the production search engine configured to generate production search results;
executing the query at a testing search engine to generate testing search results, the testing search engine configured differently from the production search engine;
generating a set of result pairs by pairing each of a plurality of testing search results with each of a plurality of production search results;
generating a correlation coefficient using the set of result pairs based on a number of result pairs that are concordant and a number of result pairs that are discordant;
selecting a similarity threshold constraint using the correlation coefficient; and
validating the testing search engine in response to the correlation coefficient satisfying the similarity threshold constraint.

9. The method of claim 8, wherein the production search results and the testing search results are limited to a threshold number of results.

10. The method of claim 9, further comprising adding search results to the testing search results that are included in the production search results but are not included in the testing search results.

11. The method of claim 9, further comprising dropping search results from the testing search results that are not included in the production search results.

12. The method of claim 9, further comprising lowering a rank value for search results that are included the testing search results and are not included in the production search results, the correlation coefficient calculated using the rank value.

13. The method of claim 8, further comprising replacing the production search engine with the testing search engine in response to the similarity threshold constraint being satisfied.

14. The method of claim 8, further comprising, generating a difference by subtracting the number of discordant pairs from the number of concordant pairs, the correlation coefficient calculated by dividing the difference by a number of data pairs in the set of result pairs.

15. A non-transitory machine-readable medium having instructions stored thereon, which, when executed by a processor, cause the processor to perform:
retrieving a query submitted to a production search engine, the production search engine configured to generate production search results;
executing the query at a testing search engine to generate testing search results, the testing search engine configured differently from the production search engine;
generating a set of result pairs by pairing each of a plurality of testing search results with each of a plurality of production search results;
generating a correlation coefficient using the set of result pairs based on a number of result pairs that are concordant and a number of result pairs that are discordant
selecting a similarity threshold constraint using the correlation coefficient; and
validating the testing search engine in response to the correlation coefficient satisfying the similarity threshold constraint.

16. The non-transitory machine-readable medium of claim 15, wherein the production search results and the testing search results are limited to a threshold number of results.

17. The non-transitory machine-readable medium of claim 16, wherein the instructions further cause the processor to perform adding search results to the testing search results that are included in the production search results but are not included in the testing search results.

18. The non-transitory machine-readable medium of claim 16, wherein the instructions further cause the processor to perform dropping search results from the testing search results that are not included in the production search results.

19. The non-transitory machine-readable medium of claim 15, wherein the instructions further cause the processor to perform replacing the production search engine with the testing search engine in response to the similarity threshold constraint being satisfied.

20. The non-transitory machine-readable medium of claim 15, wherein the instructions further cause the processor to generating a difference by subtracting the number of discordant pairs in the set of pairs from the number of concordant pairs in the set of pairs, the correlation coefficient calculated by dividing the difference by a number of data pairs in the set of result pairs.
